(19) United States
(12) Patent Application Publication
(10) Pub. No.: US 2025/0387781 A1
(43) Pub. Date: Dec. 25, 2025

(54) RENEWABLE SOLID BIOMASS SLURRY HYDROCONVERSION CATALYST, METHOD OF MAKING, AND SLURRY HYDROCONVERSION PROCESS

(71) Applicant: CHEVRON U.S.A. INC., San Ramon, CA (US)

(72) Inventors: Bo KOU, Albany, CA (US); Shuwu YANG, Richmond, CA (US); Julie CHABOT, Novato, CA (US); Theodorus Ludovicus Michael MAESEN, Spring, TX (US); Michelle K. YOUNG, Manvel, TX (US)

(21) Appl. No.: 18/878,835

(22) PCT Filed: Jun. 23, 2023
(86) PCT No.: PCT/IB2023/056520

§ 371 Date: Dec. 24, 2024

Related U.S. Application Data
(60) Provisional application No. 63/355,560, filed on Jun. 24, 2022.

(51) Int. Cl. B01J 31/02; B01J 23/28; B01J 37/02; C10G 47/26

(52) U.S. Cl. CPC B01J 31/02; B01J 23/28; B01J 37/0201; C10G 47/26

(57) ABSTRACT

A slurry hydroconversion catalyst is described formed from solid biomass having a porous structure with the pores containing slurry catalyst precursor. The slurry hydroconversion catalyst is made by impregnating the porous structure with slurry catalyst precursor. The catalyst is useful in hydroconversion processes to convert feedstocks, including hydrocarbonaceous feeds and biomass feeds, to liquid and gas products, including renewable fuels and other renewable products. The hydroconversion process may utilize solid biomass to prepare the slurry catalyst and as a feedstock and does not require the use of chemically processed or modified biomass. Low coke yields and other benefits may be obtained.

### CROSS REFERENCE TO RELATED APPLICATIONS

This application is related to and claims the benefit of priority to U.S. Provisional Patent Appl. Ser. No. 63/355,560 filed on 24 Jun. 2022, entitled “RENEWABLE SOLID BIOMASS SLURRY HYDROCONVERSION CATALYST, METHOD OF MAKING, AND SLURRY HYDROCONVERSION PROCESS”, the disclosure of which is herein incorporated in its entirety.

### FIELD OF THE INVENTION

The present disclosure relates to a renewable biomass slurry hydroconversion catalyst, a process of making the catalyst, and to a slurry hydroconversion process using the catalyst.

### BACKGROUND OF THE INVENTION

The use of renewable resources has garnered significant attention and effort in the drive to develop fossil fuel alternatives. The variety, availability and versatility of various biomass materials has been of great interest, particularly certain solid lignocellulosics and other carbohydrates, leading to the development and commercial use of a number of bio-based fuel technologies. Ongoing economic interests, and the desire to reduce fossil fuel use, have provided incentives for improvements in existing technologies, and the development of new processes for utilizing solid biomass to produce renewable fuels and other renewable products.

Renewable fuels (biofuels) are seen as being important to reduce carbon and greenhouse emissions. Biofuels derived from food are fuels typically made from food sources produced on arable land, while biofuels derived from non-food sources are typically produced from lignocellulosic biomass like forestry residuals or agricultural residues/waste. Renewable fuels derived from non-food sources are preferred over biofuels derived from competing biomass food sources. Typical non-food source feedstocks include wood, grasses, algae, crop byproduct, municipal solid waste, and the like.

Slurry catalysts have been used to process renewable feedstocks and other hydrocarbonaceous feedstocks into various products. In some cases, the use of slurry hydroprocessing requires the feedstock to the slurry process to be limited or pre-processed to be suitable for slurry hydroprocessing or to reduce fouling of conventional slurry catalysts. Examples of conventional supported slurry catalysts include support materials such as refractory base carriers comprising alumina, silica, magnesia, titania, zeolite, silica-aluminate, carbon, phosphorous, and the like, as well as combinations thereof. See, e.g., U.S. Pat. Nos. 8,795,472; 8,802,586; 8,022,259; and 9,593,242. Coke formation and contaminant deposition on conventional supported catalysts can lead to reduced catalytic activity and catalyst lifetime and result in significantly increased operating costs.

It would be a significant advantage if a simplified process was provided for the direct use of solid biomass in a hydroconversion process for producing renewable fuels (or products useful to make renewable fuels). Reduced pre-processing of the solid biomass or the use of conventional catalyst support materials would be beneficial. The use of high biomass content feeds that minimize or eliminate the use of fossil fuel co-feeds is particularly desirable in light of global efforts to utilize methods that reduce fossil fuel use. It would be very desirable to provide a cost and energy efficient way of processing solid biomass into renewable fuels having chemical compositions similar to fossil fuels in a manner that alleviates the concerns and problems associated with the use of conventional slurry catalysts for biomass hydroprocessing.

### SUMMARY OF THE INVENTION

The present invention is generally directed to renewable biomass feed slurry hydroprocessing. In one aspect, a solid biomass slurry hydroconversion catalyst is provided in which the solid biomass has a porous structure and a pore volume, with slurry catalyst precursor contained within the solid biomass pores. The catalyst precursor generally comprises a Group VIB metal, or a Group VIII metal, or a Group IIB metal, or a combination thereof.

In another aspect, a method of making a solid biomass slurry hydroconversion catalyst is provided, the method comprising contacting solid biomass feedstock having a porous structure and a pore volume with a slurry catalyst precursor under conditions sufficient to impregnate the pores of the solid biomass with the slurry catalyst precursor; and recovering the impregnated solid biomass feedstock having pores that are impregnated with the slurry catalyst precursor. The slurry catalyst precursor generally comprises a Group VIB metal, or a Group VIII metal, or a Group IIB metal, or a combination thereof.

In a further aspect, a slurry hydroconversion process is provided, the process comprising contacting a solid biomass slurry hydroconversion catalyst with a feedstock in the presence of hydrogen under slurry hydroconversion conditions to convert a portion of the feedstock to liquid and/or gas products. The solid biomass slurry hydroconversion catalyst generally comprises solid biomass having a porous structure and a pore volume with the pores containing slurry catalyst precursor. The slurry catalyst precursor generally comprises a Group VIB metal, or a Group VIII metal, or a Group IIB metal, or a combination thereof.

The present catalyst and hydroconversion process provides several advantages and benefits. For example, due to the direct support of catalytically active sites on solid biomass that is also a hydroconversion feedstock, high catalytic activity may result due to proximity of the active sites and the feedstock. The preparation of the solid biomass hydroconversion catalyst also provides a cost-effective approach to making biomass slurry catalysts and using biomass slurry catalysts in hydroconversion processes. Improved performance further results from better dispersion of catalytically active sites (i.e., lower concentration of active sites on the biomass support) and the conversion of the biomass support as a feedstock during the hydroconversion process.

### DETAILED DESCRIPTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Unless otherwise indicated, the following terms have the meanings as defined hereinbelow.

The term “hydroconversion” refers to processes or steps performed in the presence of hydrogen for the hydrocracking, hydrogenation, hydrodeoxygenation, hydrodesulfurization, hydrodenitrogenation, hydrodemetallation, hydrodechlorination, hydrodecarboxylation, hydrodecarbonylation and/or hydrodearomatization (e.g., impurities) of a hydrocarbon or biomass feedstock, and/or for the hydrogenation of unsaturated compounds in the feedstock. Depending on the type of hydrocracking and the reaction conditions, products of hydrocracking processes may have improved aromatic content, oxygen content, viscosities, viscosity indices, saturates content, low temperature properties, volatilities and depolarization, for example.

The term “conventional catalyst support” is used according to the normal usage in the art and includes typical catalyst support materials such as alumina, silica-alumina, activated carbon, zeolites and non-zeolite molecular sieves, and the like. The biomass materials used in the invention are not conventional catalyst supports and may be referred to as “unconventional” or “unconventional support materials”, and the like.

“Catalyst precursor” refers to a compound containing one or more catalytically active metals, from which compound the slurry catalyst is eventually formed, and which compound may be catalytically active as a hydroprocessing catalyst. An example is a water-based catalyst prior to a transformation step with a hydrocarbon diluent, another example is a sulfided metal precursor. Catalyst precursors and the preparation of slurry catalysts are described in various patents, e.g., U.S. Pat. No. 8,802,586, WO 2012/092006, and the like.

The term “biomass” is intended to refer to any suitable biomass feedstock, including biomass that has not been chemically processed or modified prior to being used in the process, as well as biomass that has been mechanically and/or chemically modified. Chemically processed or modified biomass materials include, e.g., lignocellulosic materials that have been treated to remove or reduce the content of certain components, or modify such components, such as the removal of cellulose or hemicellulose or the modification of lignin. Other modified biomass materials may include biomass materials that have been modified through torrefaction, or biomass treated using slow pyrolysis, fast or flash pyrolysis, hydrothermal liquefaction, hydropyrolysis, kraft processing, and the like. Biomass materials may include mechanically modified biomass materials or dried biomass materials. Thermally processed biomass materials may be “biomass” materials within the context of the invention, including when such biomass materials are chemically modified, e.g., pyrolysis products derived from biomass. Typical drying processes do not alter the biomass composition and only remove moisture and are therefore not chemical modifications.

The term “pore volume”, as used to describe the porosity of solid biomass, may be described in terms of the “wet pore volume” and the “pore volume” determined by mercury intrusion. The “incipient wet pore volume” or “wet pore volume” is measured by the incipient wetness impregnation method. In the method, an amount of dried biomass is impregnated with a liquid, typically water, by capillary action until all the biomass pores are saturated. The wet “pore volume” is calculated by dividing the total volume of water absorbed in the biomass pores by the total weight of the solid biomass. The mercury intrusion pore volume of the solid biomass is measured according to ASTM D4284, and is typically provided by a commercial mercury intrusion porosimeter.

The Periodic Table of the Elements referred to in this disclosure is the CAS version published by the Chemical Abstract Service in the Handbook of Chemistry and Physics, 72nd edition (1991-1992).

Unless otherwise specified, the recitation of a genus of elements, materials, or other components from which an individual component or mixture of components can be selected is intended to include all possible sub-generic combinations of the listed components and mixtures thereof. Also, “include” and its variants are intended to be non-limiting, such that recitation of items in a list is not to the exclusion of other like items that may also be useful in the materials, compositions, and methods of this invention.

While certain advantages in using porous solid biomass as the support for catalyst metals are mentioned hereinabove, it should be noted that other benefits may be provided as well. For example, since a separate catalyst support material is not required, the biomass support itself is available for hydroconversion and may be typically consumed in the process. The need for handling spent catalyst support material may therefore be reduced or eliminated when (or to the degree) the biomass support is consumed in the reaction. The use of a biomass support also provides for greater dispersion of the catalyst within the reaction and the ability to use the catalyst with a greater variety of feedstock forms. Certain product benefits may also be realized, including reduced coke yield, which may be less than about 8 wt. %, or about 5 wt. % of the biomass fed to the process. The liquid product oxygen content may also be less than about 3 wt. % or less than about 1 wt. %, and/or the total acid number (TAN) may be less than about 1.

While not limited thereto, the process of the invention may be used to provide a renewable fuel or a product component useful to make a renewable fuel from the liquid and/or gas products derived from the process.

The solid biomass slurry hydroconversion catalyst comprises solid biomass and slurry catalyst precursor contained within the biomass porous structure. The slurry catalyst precursor contained within the solid biomass porous structure comprises a Group VIB metal, or a Group VIII metal, or a Group IIB metal, or a combination thereof.

The solid biomass may comprise a solid biomass component selected from wood or wood mill byproduct, tree leaves, grass, algae, crop byproduct, municipal solid waste, or a combination thereof, optionally, wherein the solid biomass component is ground, pulverized, chipped or in a particulate, pellet, powder, shaving, chip, dust, or pulverized form, or a combination thereof. For example, the slurry hydroconversion catalyst may be in the form of fine particulates comprising a biomass supported catalyst formed from the catalyst precursor, and may include unsupported catalyst formed from the catalyst precursor. The fine particulates may typically be the same size and shape as the solid biomass feedstock. Any porous biomass may be used, including, but not limited to, hard wood, soft wood, algae, crop byproduct, etc. Biomass materials can be crushed or otherwise treated to any desired size or size range, e.g., to 50 microns to 10 mm, or into wood chips up to 3 cm in length, and the like.

In general, the solid biomass is porous and may be provided as biomass containing porous biomass components. Such biomass may be used in any form provided it is porous, e.g., it may be chemically processed or modified prior to being used to make the slurry hydroconversion catalyst or may be unprocessed or unmodified. The solid biomass may comprise lignocellulosic materials that have not been chemically processed. In some embodiments, certain modified biomass materials such as lignin, e.g., from a papermaking process, may also be used as porous solid biomass within the context of the invention. In other embodiments, the solid biomass may include chemically modified components, e.g., to increase the absorption and impregnation of oil and/or water-based catalyst precursors.

The solid biomass typically has a pore volume of the solid biomass as measured by mercury intrusion of less than about 3 ml/g, or 2.5 ml/g, or 2 ml/g, or 1.5 ml/g, or 1 ml/g, or in the range from about 0.1 to 3 ml/g, or 0.3 to 3 ml/g, or 0.5 to 3 ml/g, or 0.5 to 2.5 ml/g, or 0.5 to 2 ml/g.

The slurry hydroconversion catalyst is generally dispersed within reactor liquid reaction medium and contains the catalyst precursor comprising a Group VIB, Group VIII, or Group IIB metal, or a combination thereof, within the biomass porous structure of the solid biomass. The biomass slurry catalyst may be unsulfided or pre-sulfided before being added to the reactor. The biomass slurry catalyst may also be dispersed within a hydrocarbon oil diluent. A sufficient amount of slurry catalyst is typically fed to a slurry reactor(s) for the reactor to have a slurry catalyst concentration of from 300 wppm, or 500 wppm, or up to about 3 wt. % (catalyst metal to feedstock ratio). The slurry catalyst may comprise one or more different slurry catalysts as a single combined feed stream or as separate feeds to the reactor.

In some cases, the slurry hydroconversion catalyst comprises an catalyst selected from molybdenum sulfide, iron sulfide, nickel sulfide, zinc sulfide, iron zinc, or a combination thereof. The slurry catalyst may also be provided in the form of a catalyst precursor selected from oil soluble Group VIB metal (e.g., molybdenum) compounds, water soluble Group VIB metal (e.g., molybdenum) compounds, aqueous Group VIB metal (e.g., molybdenum) trisulfide suspension or colloid, or a combination thereof.

Suitable slurry catalyst precursors, slurry catalysts formed from such catalyst precursors, and the preparation of slurry catalysts are described in various patents, e.g., U.S. Pat. No. 8,802,586, WO 2012/092006, US 2015/0329790A1, and the like. Catalysts and precursors used in typical slurry hydroprocessing systems may comprise at least one Group VIB metal (e.g., Mo), optionally, with at least one Group VIII metal (e.g., Ni and/or Co), and optionally at least one Group IIB metal (e.g., Zn). Such precursors may also be used to form active catalyst within biomass materials according to the invention. In some cases, the slurry catalyst may be formed from a multi-metallic catalyst precursor comprising at least two Group VIB metals, optionally with at least one Group VIII metal wherein the ratio of the at least two Group VIB metals to the Group VIII metal is from 10:1 to 1:10.

In some cases, slurry catalysts according to the invention (on a dry basis) may contain from about 1 to 60 wt. %, or 10-60 wt. %, or 10-50 wt. % of the at least one Group VIB metal (calculated as metal oxide), optionally with from 0.5 to 30 wt. %, or 2-20 wt. % of at least one Group VIII metal (calculated as metal oxide)), and optionally with at least one Group IIB metal. In other cases, the Group VIB metal content may be greater than 30 wt. %. The weight ratio of the Group VIII and/or Group IIB metal to the Group VIB metal may be in the range of 1 to 90%, or 2 to 50%, or 5 to 30%, or 10 to 20%.

The slurry catalyst formed according to the invention may be of the formula

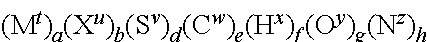

wherein, M represents at least one Group VIB metal, such as Mo, W., etc., or a combination thereof, and X functions as a promoter metal, representing at least one of a non-noble Group VIII metal such as Fe, Ni, Co; a Group IVB metal such as Ti; a Group IIB metal such as Zn; and combinations thereof (X being a “Promoter Metal”). Superscripts t, u, v, w, x, y, and z represent the total charge for each of M, X, S, C, H, O and N, respectively; and wherein (ta+ub+vd+we+xf+yg+zh)=0. The subscript ratio of b to a has a value of from 0 to 5 (0≤b/a≤5). S represents sulfur with subscript d having a value of from (a+0.5b) to (5a+2b). C represents carbon with subscript e having a value of from 0 to 11 (a+b). H is hydrogen with subscript f having a value of from 0 to 7(a+b). O represents oxygen with subscript g having a value of from 0 to 5(a+b). N represents nitrogen with subscript h having a value of 0 to 0.5(a+b). Subscript b has a value of 0 in some embodiments, e.g., for a single metallic component catalyst such as a Mo only catalyst and having no promoter.

The slurry catalyst may be prepared from catalyst precursor compositions including organometallic complexes or compounds, e.g., oil soluble compounds or complexes of transition metals and organic acids. Examples of such compounds include naphthenates, pentanedionates, octoates, and acetates of Group VIB and Group VIII metals.

The slurry catalyst may be in the form of fine particulates having the same nominal size and shape as the biomass feed. The slurry catalyst may generally be any desired shape and size or size range, e.g., an average particle size in the range of 50 microns to 10 mm. Large particle sizes including wood chips up to about 3 cm in length, and the like, may also be used. The slurry hydroconversion catalyst may be unsulfided or pre-sulfided before being added to the reactor. Methods and conditions for pre-sulfiding or in-situ sulfiding of catalysts are not particularly limited and may be performed according to conditions known in the art.

In general, the method of making the solid biomass slurry hydroconversion catalyst comprises contacting solid biomass feedstock having a porous structure and a pore volume with a slurry catalyst precursor under conditions sufficient to impregnate the pores of the solid biomass with the slurry catalyst precursor, and recovering the impregnated solid biomass feedstock having pores that are impregnated with the slurry catalyst precursor. The slurry catalyst precursor comprises a Group VIB metal, or a Group VIII metal, or a Group IIB metal, or a combination thereof.

The solid biomass may be used as a support for the active catalyst and prepared by any suitable method, including, e.g., by the use of dry, incipient and wet impregnation techniques. For example, in the incipient wetness technique, biomass is mixed with aqueous solutions of catalytic precursor metal to impregnate the biomass with the precursor. If desired, the impregnated biomass may then be dried in any appropriate manner, such as by using sequential drying ovens, or by drying over heated conveying belts, and the like. The impregnation results in a concentration of impregnated catalyst metals of from about 0.01 to 10.0 wt. %, or, more particularly, 0.01 to 2 wt. % of the total biomass.

The impregnated biomass may be present in a concentration relative to a feedstock of from 0.01 to 100.0 wt. %, or from 0.1 to 40.0 wt. %, or less than 25 wt. %. Multiple impregnation and drying steps may also be used. In some cases, higher concentrations of biomass slurry catalyst may be obtained by impregnating the biomass material by spray application of aqueous Group VIB metal compounds onto the biomass material. Further details concerning impregnation techniques are disclosed in the patent literature. See, e.g., U.S. Pat. Nos. 4,559,130; 5,190,641.

In the hydroconversion process of the invention, the solid biomass slurry hydroconversion catalyst and any additional feedstock, such as liquid hydrocarbon or biomass feedstock, may be separately fed to a hydroconversion reactor. Combinations of one or more of the feedstocks and one or more solid biomass slurry hydroconversion catalysts may be used. The slurry biomass hydroconversion catalyst, any solid biomass feedstock, any liquid feedstock, and hydrogen may be pre-mixed in any combination or amount before being fed to the hydroconversion reactor.

The feeds to the hydroconversion reactor may generally comprise at least about 10 wt. % solid biomass slurry hydroconversion catalyst, 0-90 wt. % liquid feedstock, and 0-80 wt. % solid biomass feedstock. One or more liquid products and/or slurry catalyst may also be recycled to the hydroconversion reactor. In general, any suitable hydroconversion process conditions may be used. For example, typical hydroconversion (hydrocracking) process conditions include operation within a temperature range of about 650-950° F., a reactor pressure of about 300-3000 psig, an average residence time of from 10 min to 10 hrs, and a space velocity of about 0.1 to 5.0, or 0.5 to 5.0, or 0.5 to 2.0 hr⁻¹. Mixing within the reactor helps to improve solids dispersion and the reactor thermometry and may be accomplished using mechanical mixing, liquid recirculation, gas bubbling, and the like.

The solid biomass slurry hydroconversion catalyst may be used directly in solid form or as a slurry in a liquid feedstock. Transfer of the solid biomass slurry hydroconversion catalyst to the reactor may be through a variety of single or combined means, including, e.g., the use of a pressure transfer vessel, extruders, a rotatory valve, or a lock hopper. Solid biomass feed to the hydroconversion reactor may comprise about 80-100 wt. % solid biomass and 0-20 wt. % liquid, including suitable feedstocks.

The biomass used in the solid biomass slurry hydroconversion process, including porous solid biomass used in the catalyst, may undergo various reactions, including hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization, or a combination thereof.

The liquid feedstock may generally comprise a heavy boiling point component having a boiling point of at least about 800° F. For example, while not limited thereto, the liquid feedstock may typically be selected from vacuum gas oil, atmospheric resid, vacuum resid, FCC heavy cycle oil or decanted oil, FCC medium cycle oil, hydrocracker unconverted oil, or a combination thereof. The heavy boiling point component having a boiling point of at least about 800° F. may be present in the liquid feedstock in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %. The liquid feedstock may comprise one or more components having a high boiling point of at least about 650° F., or 675° F., or 700° F., or 725° F., or 750° F. The amount of the liquid feedstock component having a high boiling point present in the liquid feedstock may be at least about 10 wt. %, or 20 wt. %, or 30 wt. %, or 40 wt. %, or 50 wt. %, or 60 wt. %, or 70 wt. %, or 80 wt. %, or 90 wt. % of the liquid feedstock.

The liquid feedstock may further comprise a renewable feedstock, such as lipid (e.g., vegetable oil, including used cooking oil, seed oils, animal fats, waste oils, algae oils, and the like), renewable biocrude, intermediate and/or product streams from thermochemical processes (e.g., pyrolysis, gasification and subsequent upgrading, and/or liquefaction), or any product or byproduct of a process using a renewable feedstock like tall oil and/or tall oil pitch, hydrothermal liquefaction product, distillation bottoms, or a combination thereof. The liquid feedstock may further comprise a feedstock derived from recycled or recovered materials (sometimes referred to as circular materials). While not limited thereto, suitable examples of recycled or recovered materials include polymers, plastics, rubbers, or a combination thereof.

In addition, the liquid feedstock may be combined with a solid biomass feedstock before being directly fed to a hydroconversion reactor. All or part of any recycled liquid product may be included as part of the liquid feedstock.

### EXAMPLES

Experimental studies were carried out to prepare solid biomass slurry hydroconversion catalysts and assess their hydroconversion performance. Wood flour was used as a representative solid biomass feedstock material and an autoclave reactor was used to assess hydroconversion performance of the biomass slurry hydroconversion catalyst.

### Example 1—Solid Biomass Pore Characterization

Pulverized wood flour was used as a representative solid biomass feedstock. The incipient (wet) pore volume was measured by incipient wetness impregnation method. About five grams of wood flour was weighed in a 50-ml beaker. Deionized water was gradually peptized into the wood flour. Capillary action drew the water into the pores of wood flour until all pores were saturated for a certain amount of time, such as one hour. Any excess liquid could be observed visually when the absorption capacity is reached. The wet pore volume is calculated by dividing the total volume of water absorbed in the pores by the total weight of the wood flour. The mercury intrusion pore volume was measured per ASTM D4284 in a Mercury Intrusion Porosimeter (Micromeritics). This test determines the intrusion pore volume distributions of a solid by the method of mercury intrusion porosimetry. The range of the applicable pore diameters is controlled by mercury intrusion pressure. The range is typically between apparent pore entrance diameters of about 0.003 micron (3 nm) to 100 microns.

A wood flour sample was used as the solid biomass feedstock and catalyst support for this test. The sample mainly came from Maple and was pulverized to 80 mesh. Mercury intrusion porosimetry was used to determine the biomass pore volume of the wood flour was 1.68 cc/g.

The results are shown in Table 1.

TABLE 1
Solid Biomass (wood flour) Pore Characteristics

| | |
|---|---|
| | Pore Volume |
| Pore Size Range | (cc/g) |

| | | |
|---|---|---|
| <1,000 | Å | 0.01 |
| 1,000-50,000 | Å | 0.55 |
| 50,000-500,000 | Å | 1.12 |

| | |
|---|---|
| >500,000 Å | 1.62 |
| (external nooks and crannies) | |

Pore volume can also be estimated by incipient wetness method. Using this method, the wood flour absorbed 1.39 cc of water per gram of the tested wood flour feedstock/catalyst support.

### Example 2—Preparation of Solid Biomass Catalyst

The wood flour biomass feedstock of Example 1 was used to support the catalyst precursor. Aqueous ammonium dimolybdate solution was used as catalyst precursor. The precursor may be supported via well-established impregnation methods, e.g., dry impregnation, wet impregnation or incipient wetness methods. In this example, the catalyst precursor was supported on the biomass feedstock by the incipient wetness method. The molybdenum to feedstock/support ratio was 1:100. This allows high dispersion of catalyst precursor and subsequent active site in the support. The supported catalyst can be used with or without drying.

### Example 3—Solid Biomass Hydroconversion

A 1000 ml autoclave reactor was charged with 400 g of heavy oil (vacuum resid (VR) and fluid cat cracker (FCC) decant oil mixture), and 100 g wood flour impregnated with aqueous ammonium dimolybdate solution containing 1 g of Mo (equivalent to 2000 ppm Mo of total feed) from Example 2. 5 g of elemental sulfur was added as a sulfiding agent. The reactor was pressurized to 2500 psig heated up to the target temperature of 805° F., and held at 805° F. for two hours. A low flow hydrogen feed was maintained during the reaction with the reactor pressure kept constant. The abundant hydrogen and gas products were vented throughout the testing. After two hours, the reactor was cooled down. The overhead product was collected from a knock-out pot downstream of the reactor, while the heavy liquid and solid product slurry were collected from the reactor. The overhead product had two layers, with the bottom aqueous layer produced mainly from hydrodeoxygenation of wood, and a liquid oil layer of light products from the hydrocracking of biomass and hydrocarbon feedstock. The reactor slurry comprised of high boiling point product, catalyst, and coke. The solids from the slurry phase were separated by filtration and analyzed. The conversion of biomass was calculated as follows:

Biomass Conversion=1−(Weight of Coke from Biomass)/(Weight of Biomass Feed)

At the end of the trial, 5.3 g of solids were collected that originated from the wood flour. The corresponding biomass conversion was 94.7%.

The foregoing results demonstrate that useful products including renewable fuel grade products may be produced from the preparation of a solid biomass slurry hydroconversion catalyst and from its use in a slurry hydroconversion process. High conversion of the solid biomass content in the catalyst is possible, and of the hydrocarbon feedstock. Prior art processes requiring the use of a liquefaction process step to pre-process the biomass is not required. Any concerns related to instability in intermediate liquefaction products should therefore be reduced as should be any concerns related to high-TAN (total acid number) content. In addition, the use of heavy oil feedstock such as vacuum resid (VR) is possible, e.g., as a liquid carrier (feedstock), without apparent aromaticity limitations.

For the avoidance of doubt, the present disclosure is directed to the subject-matter described in the following numbered paragraphs:
1. A solid biomass supported slurry hydroconversion catalyst, which is useful for producing renewable fuels, the catalyst comprising:
solid biomass having a porous structure and a pore volume wherein the solid biomass pores provide for slurry catalyst precursor to be contained therein, and
slurry catalyst precursor contained within the solid biomass porous structure, the catalyst precursor comprising a Group VIB metal, or a Group VIII metal, or a Group IIB metal, or a combination thereof.
2. The catalyst of paragraph 1, wherein the solid biomass comprises solid biomass components that have not been chemically processed or modified.
3. The catalyst of paragraph 1 or paragraph 2, wherein the solid biomass is selected from wood or wood mill byproduct, tree leaves, grass, algae, crop byproduct, municipal solid waste, or a combination thereof, optionally, wherein the solid biomass is ground, pulverized, chipped or in particulate, pellet, powder, shaving, chip, dust, or pulverized form, or a combination thereof.
4. The catalyst of any one of paragraphs 1-3, wherein the dry basis pore volume of the solid biomass as measured by mercury intrusion is less than about 3 ml/g, or 2.5 ml/g, or 2 ml/g, or 1.5 ml/g, or 1 ml/g, or in the range from about 0.1 to 3 ml/g, or 0.3 to 3 ml/g, or 0.5 to 3 ml/g, or 0.5 to 2.5 ml/g, or 0.5 to 2 ml/g.
5. The catalyst of any one of paragraphs 1-4, wherein the slurry hydroconversion catalyst has the same size and shape as the solid biomass.
6. The catalyst of any one of paragraphs 1-5, wherein the slurry hydroconversion catalyst is unsulfided or pre-sulfided before use as a catalyst, optionally dispersed within a hydrocarbon oil diluent, or is in the form of a solid or a slurry.
7. The catalyst of any one of paragraphs 1-6, wherein the catalyst precursor is selected from oil soluble Group VIB metal compounds, water soluble Group VIB metal compounds, aqueous Group VIB metal trisulfide suspension or colloid, or a combination thereof.
8. A method of making a solid biomass supported slurry hydroconversion catalyst, which is useful for producing renewable fuels, the method comprising:
contacting solid biomass feedstock having a porous structure and a pore volume with a slurry catalyst precursor under conditions sufficient to impregnate the pores of the solid biomass with the slurry catalyst precursor; and,
recovering the impregnated solid biomass feedstock having pores that are impregnated with the slurry catalyst precursor;
wherein the slurry catalyst precursor comprises a Group VIB metal, or a Group VIII metal, or a Group IIB metal, or a combination thereof.
9. The method of paragraph 8, wherein the solid biomass comprises solid biomass components that have not been chemically processed or modified.
10. The method of paragraph 8 or paragraph 9, wherein the solid biomass is selected from wood or wood mill byproduct, tree leaves, grass, algae, crop byproduct, municipal solid waste, or a combination thereof, optionally, wherein the solid biomass is ground, pulverized, chipped or in a particulate, pellet, powder, shaving, chip, dust, or pulverized form, or a combination thereof.
11. The method of any one of paragraphs 8-10, wherein the dry basis pore volume of the solid biomass is less than about 3 ml/g, or 2.5 ml/g, or 2 ml/g, or 1.5 ml/g, or 1 ml/g, or in the range from about 0.1 to 3 ml/g, or 0.3 to 3 ml/g, or 0.5 to 3 ml/g, or 0.5 to 2.5 ml/g, or 0.5 to 2 ml/g.
12. The method of any one of paragraphs 8-11, wherein the slurry hydroconversion catalyst has the same size and shape as the solid biomass.
13. The method of any one of paragraphs 8-12, wherein the slurry hydroconversion catalyst is unsulfided or pre-sulfided before use as a catalyst, optionally dispersed within a hydrocarbon oil diluent, or is in the form of a solid or a slurry.
14. The method of any one of paragraphs 8-13, wherein the catalyst precursor is selected from oil soluble molybdenum compounds, water soluble molybdenum compounds, aqueous molybdenum trisulfide suspension or colloid, or a combination thereof.
15. A slurry hydroconversion process, which is useful for producing renewable fuels, the process comprising:
contacting a solid biomass supported slurry hydroconversion catalyst with hydrogen under slurry hydroconversion conditions to convert the solid biomass to hydroconversion products,
wherein, the solid biomass slurry hydroconversion catalyst comprises solid biomass having a porous structure and a pore volume, the solid biomass pores providing for slurry catalyst precursor to be contained therein, and having slurry catalyst precursor contained within the solid biomass porous structure, the slurry catalyst precursor comprising a Group VIB metal, or a Group VIII metal, or a Group IIB metal, or a combination thereof.
16. The process of paragraph 15, wherein the solid biomass comprises solid biomass components that have not been chemically processed or modified.
17. The process of paragraph 15 or paragraph 16, wherein the process provides a renewable fuel or a product component useful to make a renewable fuel from the hydroconversion products.
18. The process of any one of paragraphs 15-17, wherein the process further comprises contacting a feedstock with the slurry hydroconversion catalyst, the feedstock being selected from a renewable feedstock, a circular feedstock, a liquid hydrocarbon feedstock or a combination thereof.
19. The process of any one of paragraphs 15-18, wherein the process is further conducted in the presence of an added sulfiding agent.
20. The process of paragraph 18, wherein the renewable feedstock is selected from wood pyrolysis oil, lipids, vegetable oils, or a combination thereof, or wherein the renewable feedstock comprises solid biomass.
21. The process of any one of paragraphs 18-20, wherein the circular feedstock is derived from recycled or recovered materials.
22. The process of any of paragraphs 18-21, wherein the liquid hydrocarbon feedstock comprises a heavy boiling point component having a boiling point of at least about 800° F., and/or wherein the liquid hydrocarbon feedstock is selected from vacuum gas oil, atmospheric resid, vacuum resid, FCC heavy cycle oil or decanted oil, FCC medium cycle oil, hydrocracker unconverted oil, or a combination thereof.
23. The process of paragraph 18 or paragraph 19, wherein the hydroconversion process comprises a slurry hydrocracking reactor to carry out the hydroconversion and the feedstock and the slurry hydroconversion catalyst are separately fed to the slurry hydroconversion reactor, or are fed as a combination of the feedstock and the slurry hydroconversion catalyst.
24. The process of any of paragraphs 18-23, wherein the feedstock is least about 10 wt. %, or 20 wt. %, or 30 wt. %, or 40 wt. %, or 50 wt. %, or 60 wt. %, or 70 wt. %, or 75 wt. %, or 80 wt. % of the total of the feedstock and the slurry hydroconversion catalyst fed to the hydroconversion reactor.
25. The process of any of paragraphs 18-24, wherein the liquid hydrocarbon feedstock is combined with the solid biomass feedstock before being directly fed to the slurry hydroconversion reactor.
26. The process of paragraph 22, wherein the liquid hydrocarbon feedstock comprises the heavy boiling point component in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %.
27. The process of any of paragraph 15-26, wherein a liquid product is recycled.
28. The process of any of paragraph 15-27, wherein the solid biomass is selected from wood or wood mill byproduct, tree leaves, grass, algae, crop byproduct, municipal solid waste, or a combination thereof, optionally, wherein the solid biomass is ground, pulverized, chipped or in a particulate, pellet, powder, shaving, chip, dust, or pulverized form, or a combination thereof.
29. The process of any of paragraphs 15-28, wherein the slurry hydroconversion catalyst is unsulfided or pre-sulfided before use, optionally dispersed within a hydrocarbon oil diluent, or is in the form of a solid or a slurry.
30. The process of any one of paragraphs 15-29, wherein the slurry catalyst precursor is selected from oil soluble molybdenum compounds, water soluble molybdenum compounds, aqueous molybdenum trisulfide suspension or colloid, or a combination thereof.
31. The process of any of paragraphs 15-30, wherein the solid biomass undergoes hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization, or a combination thereof.
32. The process of any one of paragraphs 15-31, wherein the hydroconversion process conditions include operation within a temperature range of about 650-950° F., a reactor pressure of about 300-3000 psig, and an average residence time of from 10 min. to 10 hrs., or 30 min. to 5 hrs., or 30 min. to 2 hrs., and a space velocity of about 0.1 to 5.0, or 0.5 to 5.0, or 0.5 to 2.0 hr-1, and, optionally, wherein liquid product and/or slurry catalyst is recycled to the slurry hydroconversion reactor.
33. The process of any one of paragraphs 15-32, wherein the coke yield is less than about 5 wt. %, or less than about 2 wt. %, or less than about 1 wt. % of the solid biomass fed to the process.
34. The process of any one of paragraphs 15-33, wherein the liquid product oxygen content is less than about 3 wt. % or less than about 1 wt. %, and/or wherein the total acid number (TAN) is less than about 1.

The present disclosure is not to be limited in terms of the particular embodiments described in this application, which are intended as illustrations of various aspects. Many modifications and variations can be made without departing from its spirit and scope, as may be apparent. Functionally equivalent methods and systems within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, in some cases, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive.

Where permitted, all publications, patents and patent applications cited in this application are incorporated by reference herein in their entirety, to the extent such disclosure is not inconsistent with the present invention.

1. A solid biomass supported slurry hydroconversion catalyst, which is useful for producing renewable fuels, the catalyst comprising:
solid biomass having a porous structure and a pore volume wherein the solid biomass pores provide for slurry catalyst precursor to be contained therein, and
slurry catalyst precursor contained within the solid biomass porous structure, the catalyst precursor comprising a Group VIB metal, or a Group VIII metal, or a Group IIB metal, or a combination thereof.

2. The catalyst of claim 1, wherein the solid biomass comprises solid biomass components that have not been chemically processed or modified.

3. The catalyst of claim 1, wherein the solid biomass is selected from wood or wood mill byproduct, tree leaves, grass, algae, crop byproduct, municipal solid waste, or a combination thereof, optionally, wherein the solid biomass is ground, pulverized, chipped or in particulate, pellet, powder, shaving, chip, dust, or pulverized form, or a combination thereof.

4. The catalyst of claim 1, wherein the dry basis pore volume of the solid biomass as measured by mercury intrusion is less than about 3 ml/g, or 2.5 ml/g, or 2 ml/g, or 1.5 ml/g, or 1 ml/g, or in the range from about 0.1 to 3 ml/g, or 0.3 to 3 ml/g, or 0.5 to 3 ml/g, or 0.5 to 2.5 ml/g, or 0.5 to 2 ml/g.

5. The catalyst of claim 1, wherein the slurry hydroconversion catalyst has the same size and shape as the solid biomass.

6. The catalyst of claim 1, wherein the slurry hydroconversion catalyst is unsulfided or pre-sulfided before use as a catalyst, optionally dispersed within a hydrocarbon oil diluent, or is in the form of a solid or a slurry.

7. The catalyst of claim 1, wherein the catalyst precursor is selected from oil soluble Group VIB metal compounds, water soluble Group VIB metal compounds, aqueous Group VIB metal trisulfide suspension or colloid, or a combination thereof.

8. A method of making a solid biomass supported slurry hydroconversion catalyst, which is useful for producing renewable fuels, the method comprising:
contacting solid biomass feedstock having a porous structure and a pore volume with a slurry catalyst precursor under conditions sufficient to impregnate the pores of the solid biomass with the slurry catalyst precursor; and,
recovering the impregnated solid biomass feedstock having pores that are impregnated with the slurry catalyst precursor;
wherein the slurry catalyst precursor comprises a Group VIB metal, or a Group VIII metal, or a Group IIB metal, or a combination thereof.

9. The method of claim 8, wherein the solid biomass comprises solid biomass components that have not been chemically processed or modified.

10. The method of claim 8, wherein the solid biomass is selected from wood or wood mill byproduct, tree leaves, grass, algae, crop byproduct, municipal solid waste, or a combination thereof, optionally, wherein the solid biomass is ground, pulverized, chipped or in a particulate, pellet, powder, shaving, chip, dust, or pulverized form, or a combination thereof.

11. The method of claim 8, wherein the dry basis pore volume of the solid biomass is less than about 3 ml/g, or 2.5 ml/g, or 2 ml/g, or 1.5 ml/g, or 1 ml/g, or in the range from about 0.1 to 3 ml/g, or 0.3 to 3 ml/g, or 0.5 to 3 ml/g, or 0.5 to 2.5 ml/g, or 0.5 to 2 ml/g.

12. The method of claim 8, wherein the slurry hydroconversion catalyst has the same size and shape as the solid biomass.

13. The method of claim 8, wherein the slurry hydroconversion catalyst is unsulfided or pre-sulfided before use as a catalyst, optionally dispersed within a hydrocarbon oil diluent, or is in the form of a solid or a slurry.

14. The method of claim 8, wherein the catalyst precursor is selected from oil soluble molybdenum compounds, water soluble molybdenum compounds, aqueous molybdenum trisulfide suspension or colloid, or a combination thereof.

15. A slurry hydroconversion process, which is useful for producing renewable fuels, the process comprising:
contacting a solid biomass supported slurry hydroconversion catalyst with hydrogen under slurry hydroconversion conditions to convert the solid biomass to hydroconversion products,
wherein, the solid biomass slurry hydroconversion catalyst comprises solid biomass having a porous structure and a pore volume, the solid biomass pores providing for slurry catalyst precursor to be contained therein, and having slurry catalyst precursor contained within the solid biomass porous structure, the slurry catalyst precursor comprising a Group VIB metal, or a Group VIII metal, or a Group IIB metal, or a combination thereof.

16. The process of claim 15, wherein the solid biomass comprises solid biomass components that have not been chemically processed or modified.

17. The process of claim 15, wherein the process provides a renewable fuel or a product component useful to make a renewable fuel from the hydroconversion products.

18. The process of claim 15, wherein the process further comprises contacting a feedstock with the slurry hydroconversion catalyst, the feedstock being selected from a renewable feedstock, a circular feedstock, a liquid hydrocarbon feedstock or a combination thereof.

19. The process of claim 15, wherein the process is further conducted in the presence of an added sulfiding agent.

20. The process of claim 18, wherein the renewable feedstock is selected from wood pyrolysis oil, lipids, vegetable oils, or a combination thereof, or wherein the renewable feedstock comprises solid biomass.

21. The process of claim 18, wherein the circular feedstock is derived from recycled or recovered materials.

22. The process of claim 18, wherein the liquid hydrocarbon feedstock comprises a heavy boiling point component having a boiling point of at least about 800° F., and/or wherein the liquid hydrocarbon feedstock is selected from vacuum gas oil, atmospheric resid, vacuum resid, FCC heavy cycle oil or decanted oil, FCC medium cycle oil, hydrocracker unconverted oil, or a combination thereof.

23. The process of claim 18, wherein the hydroconversion process comprises a slurry hydrocracking reactor to carry out the hydroconversion and the feedstock and the slurry hydroconversion catalyst are separately fed to the slurry hydroconversion reactor, or are fed as a combination of the feedstock and the slurry hydroconversion catalyst.

24. The process of claim 18, wherein the feedstock is least about 10 wt. %, or 20 wt. %, or 30 wt. %, or 40 wt. %, or 50 wt. %, or 60 wt. %, or 70 wt. %, or 75 wt. %, or 80 wt. % of the total of the feedstock and the slurry hydroconversion catalyst fed to the hydroconversion reactor.

25. The process of claim 18, wherein the liquid hydrocarbon feedstock is combined with the solid biomass feedstock before being directly fed to the slurry hydroconversion reactor.

26. The process of claim 22, wherein the liquid hydrocarbon feedstock comprises the heavy boiling point component in an amount of up to about 50 wt. %, or 40 wt. %, or 30 wt. %, or 20 wt. %, or 10 wt. %, or in the range from about 10-50 wt. %, or 10-40 wt. %, or 10-30 wt. %, or 20-30 wt. %.

27. The process of claim 15, wherein a liquid product is recycled.

28. The process of claim 15, wherein the solid biomass is selected from wood or wood mill byproduct, tree leaves, grass, algae, crop byproduct, municipal solid waste, or a combination thereof, optionally, wherein the solid biomass is ground, pulverized, chipped or in a particulate, pellet, powder, shaving, chip, dust, or pulverized form, or a combination thereof.

29. The process of claim 15, wherein the slurry hydroconversion catalyst is unsulfided or pre-sulfided before use, optionally dispersed within a hydrocarbon oil diluent, or is in the form of a solid or a slurry.

30. The process of claim 15, wherein the slurry catalyst precursor is selected from oil soluble molybdenum compounds, water soluble molybdenum compounds, aqueous molybdenum trisulfide suspension or colloid, or a combination thereof.

31. The process of claim 15, wherein the solid biomass undergoes hydrocracking, hydrogenation, hydrodeoxygenation, hydrodesulfurization, hydrodenitrogenization, hydrodemetallization, hydrodechlorination, hydrodecarboxylation, hydrodecarbonylation, hydrodearomatization, or a combination thereof.

32. The process of claim 15, wherein the hydroconversion process conditions include operation within a temperature range of about 650-950° F., a reactor pressure of about 300-3000 psig, and an average residence time of from 10 min. to 10 hrs., or 30 min. to 5 hrs., or 30 min. to 2 hrs., and a space velocity of about 0.1 to 5.0, or 0.5 to 5.0, or 0.5 to 2.0 hr⁻¹, and, optionally, wherein liquid product and/or slurry catalyst is recycled to the slurry hydroconversion reactor.

33. The process of claim 15, wherein the coke yield is less than about 5 wt. %, or less than about 2 wt. %, or less than about 1 wt. % of the solid biomass fed to the process.

34. The process of claim 15, wherein the liquid product oxygen content is less than about 3 wt. % or less than about 1 wt. %, and/or wherein the total acid number (TAN) is less than about 1.
